(19) United States
(12) Patent Application Publication
(10) Pub. No.: US 2004/0158515 A1
(43) Pub. Date: Aug. 12, 2004

(54) Home asset value enhancement notes (HAVENs)

(76) Inventor: Neil C. Schoen, Montgomery Village, MD (US)

Correspondence Address: Neil C. Schoen, 9817 Freestate Place, Montgomery Village, MD, 20886-3158, US

(21) Appl. No.: 10/759,145

(22) Filed: Jan. 20, 2004

Related U.S. Application Data
(60) Provisional application No. 60/442,552, filed on Jan. 27, 2003.

(51) Int. Cl. G06F 17/60

(52) U.S. Cl. 705/35

(57) ABSTRACT

Financial instruments to protect the value of residential homes are described. A method for generation of publicly traded notes backed by ownership of single family homes to allow financial markets to provide instruments for investors and home owners to profit from price changes in the value of single family homes. A fraction of the title to the land and dwelling of many single family homes are bundled, separately from that of the traditional mortgages, creating the equivalent of mortgage-backed-securities such as Ginnie Maes, which are marketed to public investors. These securities, herein referred to as home asset value enhancement notes (HAVENs), can be used by individual homeowners as a hedge against any declines in value of their individual homes. They can also be purchased by the general public as a direct investment in the aggregate value of residential real estate. Analogous to exchange traded funds (ETFs), they can be held as long or short positions, and thus are suitable for capitalizing on long-term appreciation in residential housing, or protecting house values over short or intermediate term declines in home prices, as might be done by home builders or individual home owners who are not able to hold the real estate assets over longer periods of time. HAVENs are intended to serve purposes similar to those of commodity contracts available to producers and consumers of commodities other than houses, such as precious metals, agricultural products or livestock. HAVENs differ from traditional insurance, in that no up-front payment is necessary to secure protection; instead a portion of ownership is pledged. In addition, this greatly broadens the public participation and thus spreads the risk. Traditional insurance resources based on homeowner premiums could be overwhelmed in a depression environment, increasing the risk that the homeowner would not be covered for his losses on sale of the property.

### BACKGROUND OF THE INVENTION

At the present time, there is no means for an individual home owner to protect the value of his investment in his home during periods of time when residential real estate values are declining. Traditionally, the homeowner either waits to sell his house when the real estate markets recover and he can make a profit on the sale, or if he is forced to move due to job changes or other relocation pressures, he sells at a loss. This is in contrast to the situation for other means to protect his investment, such as traditional insurance policies that cover destruction or damage to the house from a variety of causes (e.g., flood, fire, etc.). Although there have been some recent efforts to develop price protection insurance for residential homes, these approaches are along the lines of traditional insurance, and require an up-front premium. These premiums are invested by the issuing company and are used to pay any claims that ensue. There is some risk that in periods of severe price declines in residential real estate, analogous to natural disasters in conventional property insurance, that the insuring companies funds will be exhausted, thus leaving the insurance purchaser uncovered. It is unclear whether government backing of such insurance will be provided, if necessary, as is the case for federal assistance in the current insurance markets (requires presidential declaration of a disaster area in conjunction with FEMA participation).

The closest analogy to the current invention is the present markets for mortgage backed securities (MBS). These financial instruments are created by quasi-governmental agencies (e.g., government national mortgage agency (Ginnie Maes), federal national mortgage agency (Fannie Maes) and federal mortgage acceptance corporation (Freddie Mac)). These agencies bundle mortgages from individual homeowners, and issue units representing various asset claims on the underlying mortgages, which are sold to the general public. Thus there are securities that are issued that represent the principal and interest portions of the mortgage (called derivatives), which can be bundled separately; analogous examples are the zero-coupon treasury bonds, or interest-only instruments (“strips”). It is difficult to utilize these instruments in the residential home market, because these types of securities cannot be “shorted,” and thus cannot be used to protect against downward movements in the underlying price of the insured assets.

Another problem with conventional commodity-type instruments is that of “taking delivery” when the commodity contract expires. In traditional commodity markets, users of the commodity futures frequently take delivery of the quantity of the commodity covered by the contract (e.g., producers of products derived from the commodity). Speculators who do not want to purchase the full value of the contract have to sell the contract prior to expiration. This can create situations in which the investors suffer a loss if the expiration occurs at a time when the price movement has “gone against” the investor. With MBS instruments, as homes are sold, the mortgage principal is distributed to the investor; interest on the loans of all unsold properties in the bundled security are paid periodically by the home owner via his mortgage payments to the participating bank(s).

HAVENs are different in that they represent only a portion of the value of the asset, and thus the entire real estate assets are not fully controlled by the owners of the HAVEN notes. In addition, the underlying value fluctuates with the market price of residential real estate. This is in contrast to traditional MBS instruments, which are defined in redemption value (i.e., the principal is always returned at the end of the term of the loans) at the time of creation of the mortgage (but fluctuate prior to the expiration of the underlying mortgages because interest rates fluctuate and mortgages are paid off when sold before maturity).

### SUMMARY OF THE INVENTION

An equivalent organization to the MBS agencies is required to create the HAVEN instruments. This business organization would be required to collect the fractional ownership titles of a group of residential homes and bundle them as a single asset. Thus at the time the homeowner purchases a home and takes out a mortgage, a fractional ownership share of the property, as represented by a title of partial ownership would have to be held by the HAVEN business organization, along with those of other homes included in this unit security. This is the equivalent of creating a “basket” of stocks that are then sold to the public as shares of a unitary trust, as is the case for an ETF or Index Fund. In this implementation, the basket contains fractional titles to the residential houses covered by the issued unit security. The value could be determined from local real estate regional price indices, as opposed to calculating the price on the appraised values of all the homes in the unit security issued. Individual homeowners can hedge their house investment to any level they deem necessary, by shorting (or purchasing) these HAVEN notes on the open market. As is the case for ETFs and commodity futures, most purchasers have no intention of taking actual possession of the underlying assets represented by the HAVEN notes. They would normally be bought and sold before the real estate was resold.

These HAVEN instruments could function in the same way as ETFs, wherein the underlying fractional home assets are purchased by the business organization issuing the HAVEN notes, or as borrowed assets from the individual homeowners, analogous to the way brokerages borrow stock from individuals for purposes of short-selling activities. At the time the house is sold, the fractional share is returned to the owner of the mortgage, to be redeemed by the corporation at settlement. Thus, when a homeowner sells his/her property, he/she receives the fractional share market value of the home, which could be more or less than the actual value if the original HAVEN unit was based on regional prices. However, since the fractional share is small, the difference in cash back from the sale of the home is small compared to the cash back if the home was never part of a HAVEN unit. If upon home purchase, the fractional share was sold to the corporation issuing the HAVEN notes, the home buyer would receive actual cash for the fractional share at the time of purchase (in effect, an immediate payment for resale on a small portion of his home). When he sells his home, the fractional share must be returned, and the HAVEN note “principal” readjusted to reflect the change. The difference in value from the original value at the time of issue of the HAVEN note is factored into the daily price of the HAVEN note for after-market resale of the notes. If the shares were loaned to the HAVEN corporation the redemption value could be more or less than the original value at the time the home was purchased (depending on the real estate market), and thus the owner of the HAVEN notes could have a profit or a loss. The corporation would collect fees for creating these investment vehicles, so the investors would receive less money that the actual value difference in the fractional share at the time of home sale.

Because these are market-based securities, the value of the HAVEN notes at any time could fluctuate from the calculated value, due to supply-demand imbalances. However, it is expected that these fluctuations would be minor and/or temporary, as is the case for closed-end mutual funds or ETFs (due to their liquidity) based on stock fluctuations, instead of real estate fluctuations.

It is also possible to structure HAVENs as an insurance-based product. The homeowner would opt to make monthly payments to insure price protection for his home. These payments could be variable, based on the past history of appreciation (or depreciation) of an underlying basket of homes using this insurance vehicle. Guidelines for payouts would be established at the time of issuance, based on projected sale price of the home at a future date. Depending on how this product form is structured, the homeowner could get payback for some fraction of the premiums paid in during the time of ownership, depending on the value of the real estate at sale time, even if the home appreciated. If the home declined in value, the owner would receive all or some fraction of the loss, depending on the options selected by the buyer at the time of original purchase of the home.

There are many potential variations on the basic mechanisms described above. The following sections will provide detailed data and formulas for structuring these instruments for home asset financial protection.

### DESCRIPTION OF THE FIGURES

FIG. 1. is a spreadsheet table showing some of the data required to make predictions of housing values necessary to structure viable HAVEN financial instruments to protect home value.

FIG. 2. shows some of the key equations necessary to process the data in the spreadsheet table to estimate future trends in housing prices upon which the HAVEN financial instruments can be structured.

FIG. 3. identifies key variables necessary to be calculated or established in order to create the HAVEN financial instruments.

FIG. 4. shows a typical appreciation curve for housing indicating regions where premium return values might differ.

### DETAILED DESCRIPTION OF PREFERRED EMBODIMENTS

The following procedures demonstrate how to select values for the key variables that determine the structure of the HAVEN financial instruments. The first calculation that should be done involves the estimation of the change in home values over time, so that one can determine if the overall performance of the HAVEN vehicles for protecting home asset value will accomplish the objectives envisioned, as well as the selection of key parameters for creating a system.

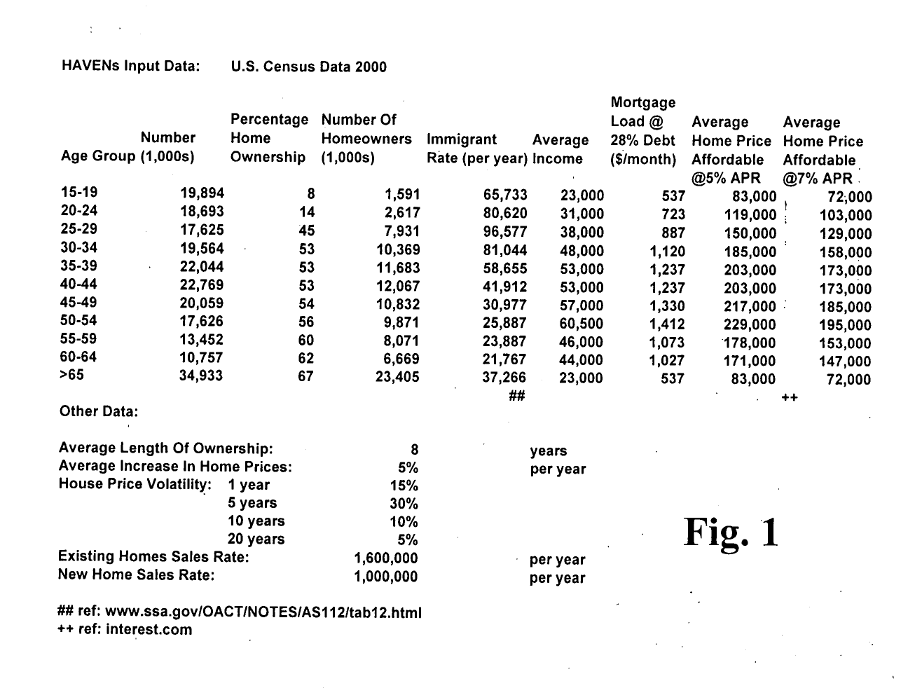

The table in FIG. 1 provides necessary information on population age demographics (including immigration) as well as data on average income for the different age brackets. Also included are data associated with the financing of housing, such as the maximum debt load for purchasing homes and the estimated home price affordable for the given income of that age bracket (shown for two assumed mortgage rates). The table also includes assumptions on the dynamics of home sales, including average holding period of a house, the average price increase, statistics on the volatility of housing prices, and the current sales rate of existing and new homes. These data are necessary in estimating future sales activity in each of the age brackets over time. A key piece of information not included is a factor called the elasticity of housing prices (per age bracket). This factor is basically a supply-demand equation or curve from basic mathematical economics. In reality, the demand portion of the equation can be estimated from the data in the table, since as home prices go up, the various age brackets selectively get “priced out of the market”. What is difficult to determine is the supply side of the equation, since that is dependent on home builders assessment of the future housing demands, the economic health of the home builders, availability of land, etc. Nonetheless, one can make an estimate of predicted housing supply based on current reported statistics on existing and new home sales and historical trends.

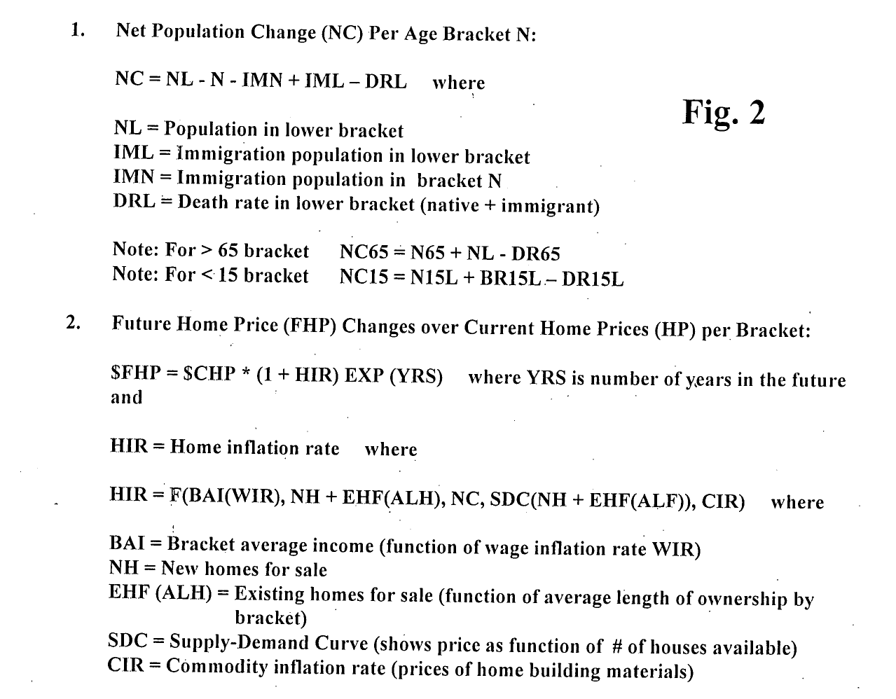

FIG. 2 provides the mathematical equations necessary to do the calculations of predicted future home sales, using the data in FIG. 1. The changes in age bracket populations is a relatively straight forward calculation, given birth, death and immigration rates. The prediction of future home quantities and prices is a lot more complex, as the variables included in the calculation of future home prices ($FHP) are many and complex, and include all the factors that enter into setting the price of a transaction: funds available to the purchaser (i.e., income), the future supply of new and existing homes, and materials inflation factors (including land prices). It is anticipated that these factors can be modeled using large, statistical (Monte Carlo) computer programs, thus allowing the needed predictions to be estimated for various assumptions about the future. Given that this is done, either via statistical methods or the generation of equations representing the key variables, one can now estimate the financial viability of providing HAVEN financial instruments to the marketplace at a profit to the issuing organization or corporation.

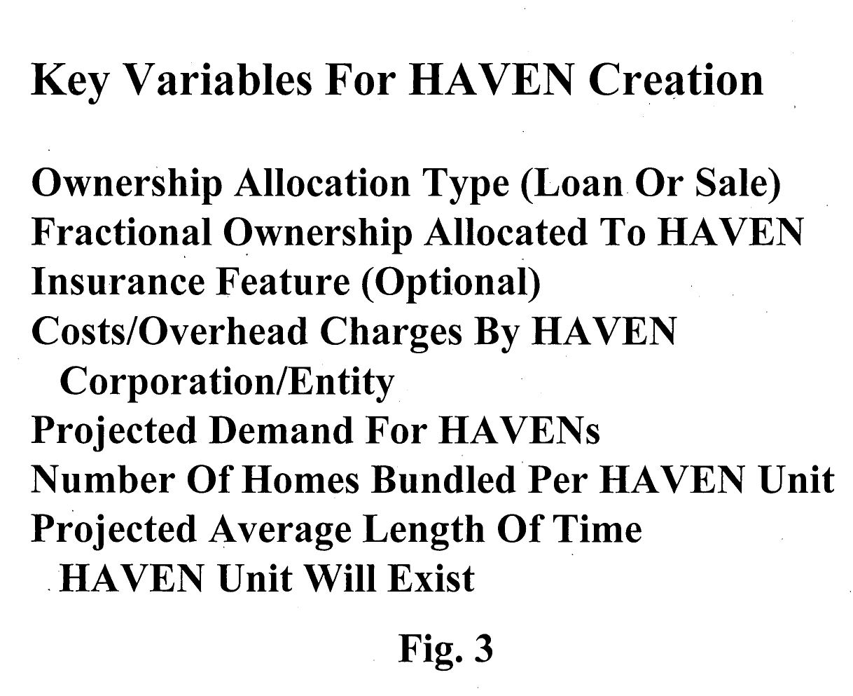

FIG. 3 provides a listing of some of the key parameters that need to be determined to issue HAVEN financial products. First, the nature of the ownership allocation to a HAVEN unit must be determined. There are two options; the fractional share of the ownership can be loaned to the creating corporation, or it can be sold. In the case of the loan option, the situation is very much like stock ownership and the technique of a short sale. A fractional ownership certificate for the homes can be loaned to the HAVEN creation organization, where they would be bundled and HAVEN notes issued for trading in public markets. If homes in the HAVEN unit are sold, then the price of the notes will be readjusted to reflect the lower asset value of the fractional share of ownership, and the change in asset value would be provided to the holder of the HAVEN note(s) from the proceeds of the sale to the homeowner. Thus, if the fractional share of ownership was set at 1%, and the house had appreciated, the owner would receive 1% less of the profits from the sale of his home. However, by shorting HAVEN notes in the public market, the owner will have protected his home value from significant loss at the 1% level, since the HAVEN notes should have moved in the opposite direction to the home price change (equivalent to “shorting against the box” in stock market transactions). The owner can determine at the time of purchase what percentage of the home value he/she wishes to protect, based on how much other money is available to purchase HAVENs in the open market.

Alternatively, the HAVENs can be established by the actual sale of a fraction of the home price to the establishing entity. The homeowner can then use that money to purchase HAVENs in the open market. In this case, the owner does not have to have the extra funds to price protect the home investment. The owner has the option at any time to switch between shorting HAVENs in the open market, or purchasing them with the funds he/she receives, in which case the owner is speculating on the investment in what he thinks is a rising market. In either case, HAVENs gives home owners the option to protect their investment in a home, at a level they choose, against declines in price.

Once the nature of the transfer of partial ownership is defined, the level of ownership retained must be determined. One option is to set a fixed percentage for use by the HAVEN corporation or entity. The homeowner can then leverage by buying similar or larger numbers of HAVEN notes to change his protection level, but this will require that the home owner have additional resources to invest in the protection. The variable percentage option would allow all homeowners to participate in the HAVEN market for hedging purposes (or speculation), but would be more difficult to administer (i.e., would require more extensive databases to on individual share contributions), since records would have to be kept to track the different percentages of ownership for each homeowner participant.

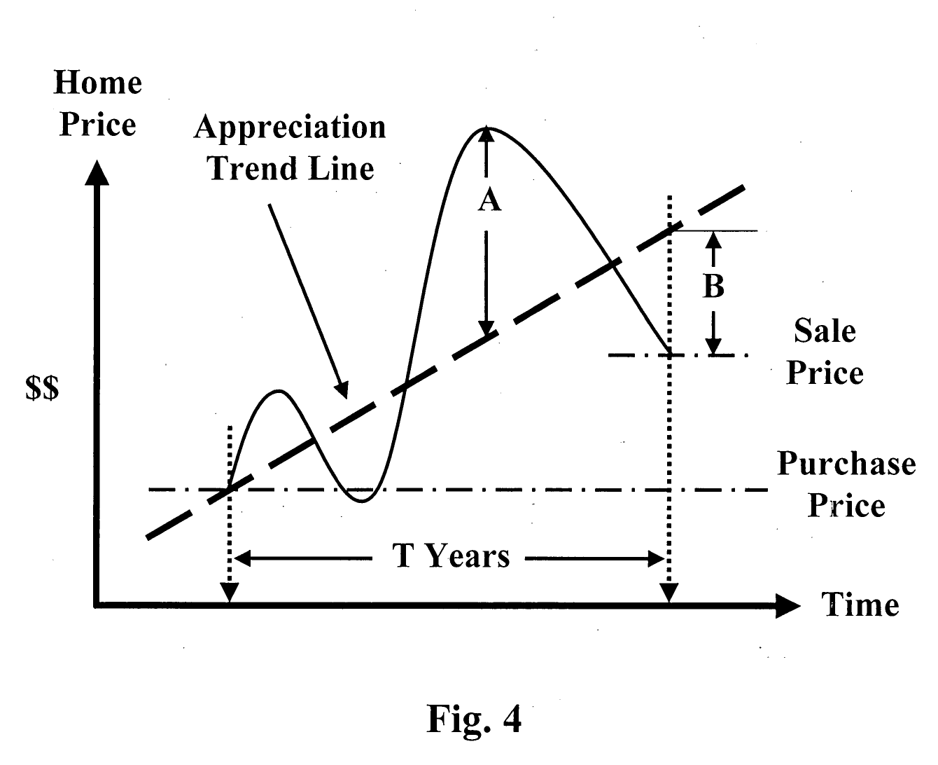

An adjunct option is to create an insurance product, with or without an equity “kicker” such as the HAVEN approach. The preferred method for the insurance option is to pay adjustable premiums over time periods, similar to property damage insurance on homes. However, due to the appreciation potential of residential real estate, an innovative return-of-premiums approach is built in to this option for home price protection. FIG. 4 shows a graphic of possible conditions leading to variable payback of premiums, with three conditions possible. The HAVEN premium value ($HPV) equation can be written as follows:

$HPV=$SP−$PP−CI%*$PP

where

$SP=home sale price after ownership period

$PP=home purchase price

CI%=compound appreciation of area real estate index=(1+I%)^{T} (after T years).

The HAVEN return of value ($HR) equation can be written as follows:

$HR=$HYP*T*F%

$HYP=total yearly payments

T=years of payments

F%=fractional premium return rate (function of time and appreciation trend)

The factor F% determining the amount of premium return can take on several values:

For $HPV>0 (price appreciation above the average trend line) F% can be a function of several variables, is set by agreement with the buyer, but always ranges between 0 and 1. Usually F% would be =0 in this case since the owner did better than average appreciation. FIG. 4 area labeled “A” shows this case.

For $HPV=0 then F%=0 and $HR=0 (price appreciation was average). For % HPV<0 then F% ranges linearly from 0 when appreciation is average, to 1 when there is no appreciation, and there is some premium return ($HR>0). FIG. 4 area labeled “B” shows this case.

The final case is when the homeowner shows a loss on the sale of the home, that is, when ($SP−$PP)<0, then the return $HR=($PP−$SP) which guarantees that the homeowner suffers no loss of principle on the sale. Another option is to collect the premium in a lump sum, but this usually will increase the mortgage value (if the owner can't come up with the extra money), upon which the homeowner is paying interest charges.

One can use the data in FIG. 1 to determine the proper level to set the premiums at, given projected price appreciation, the number of potential insurance buyers, the probability of a house price decline, and other factors. This insurance mechanism also can be combined with the market-based HAVEN financial instrument to provide a variety of protection options to the home buyer.

1. A financial instrument to protect the value of residential real estate, comprising;
means in the form of a financial business entities to administer the creation and distribution of said financial instrument, wherein said business entities functions comprise;
means to secure fractional ownership of said residential real estate, wherein said means is selected from a group comprising; a purchase or loan of said real estate, or a combination of both;
means to provide a form for said financial instrument, wherein;
said form is selected from a group comprising; deeds of fractional ownership of said real estate, fractional ownership mortgage-backed securities (MBS) of said real estate, loan notes of said fractional ownership of said real estate, insurance policies on said fractional ownership, or a combination of said forms;
means to provide for a source of funds to create and sell said financial instruments to public markets in forms selected from a group comprising; exchange traded funds (ETFs), commodity futures, index funds, or annuities.

2. A financial instrument according to claim 1 wherein said means to secure fractional ownership of said residential real estate is in the form of a direct purchase by said financial business entities of a fractional share from each participating residential real estate property owner, wherein said fractional purchases are secured by fractional deeds of trust on the purchased properties, and wherein;
any profit from the sale of a participating real estate property is disbursed in a manner selected from a group comprising; retention of all profit by said financial business entities, or a sharing of profits above a set appreciation rate with said property owner as an inducement to participate in creating said financial instrument.

3. A financial instrument according to claim 1 wherein said means to secure fractional ownership of said residential real estate is in the form of a loan note to said financial business entities of a fractional share from each participating residential real estate property owner, wherein said loan notes are secured by fractional deeds of trust on the purchased properties, and wherein;
any profit from the sale of a participating real estate property is disbursed in a manner selected from a group comprising; return of said loan note to said property owner with no accrued interest or payment, or a sharing of profits from the sale of said property above a set appreciation rate with said property owner as an inducement to participate in creating said financial instrument.

4. A financial instrument according to claim 1 wherein said means to secure fractional ownership of said residential real estate is selected from a group comprising;
a no-cost transfer to said financial business entities of a fractional share from each participating residential real estate property owner wherein said no-cost transfer of fractional deeds of trust on the purchased properties pays for insurance against loss of said owner property value, or;
payment of premiums to said financial business entities for insurance against loss of said owner property value, and wherein;
any profit from the sale of a participating real estate property is disbursed in a manner to provide an inducement to participate in creating said financial instrument, selected from a group comprising;
no return of the original value of said no-cost transfer of fractional deeds of trust on the purchased property if said property owner sells his property at a profit, or a sharing of profits from the sale of said fractional deeds of trust on said property above a set appreciation rate with said property owner, or;
return of a fraction said premiums for insurance against loss of said property.
